(19) United States
(12) Patent Application Publication
(10) Pub. No.: US 2011/0222480 A1
(43) Pub. Date: Sep. 15, 2011

(54) SYSTEM AND METHOD FOR PROVIDING WIRELESS COMMUNICATION TO A WIND FARM

(76) Inventor: Donald Ray Perigo, Marietta, GA (US)

(21) Appl. No.: 13/080,384

(22) Filed: Apr. 5, 2011

(51) Int. Cl. H04W 88/08

(52) U.S. Cl. 370/328

(57) ABSTRACT

A system and method of providing wireless communication to a user computing device at a wind turbine including a tower, a nacelle, and a plurality of rotor blades defining a sweep area. The method includes coupling a wireless bridge to an exterior of the wind turbine, the wireless bridge configured to receive the wireless communication signal and coupling a wireless access point to the wind turbine near a roof of the wind turbine, wherein the wireless access point is configured to communicate with at least one user computing device within an access area of the wind turbine, the access area including an interior of the tower and the nacelle, and the sweep area. The method also includes communicatively coupling the wireless bridge to the wireless access point, and configuring the wireless bridge to forward, to a remote device, a data request from the user computing device, the data request received from the wireless access point.

### BACKGROUND OF THE INVENTION

The field of the invention relates generally to providing wireless communication to a wind farm, within a turbine, and more particularly, to providing wireless communication to service areas surrounding a wind turbine.

A wind farm includes one or more wind turbines, which utilize wind energy to generate or produce electrical power. During the maintenance and/or repair of wind turbines within a wind farm, service technicians often have difficulty communicating locally or with a remote site due to a lack of cellular or wireless internet coverage.

### BRIEF DESCRIPTION OF THE INVENTION

A method of providing wireless communication to a user computing device at a wind turbine including a tower, a nacelle, and a plurality of rotor blades defining a sweep area is provided. The method includes coupling a wireless bridge to an exterior of the wind turbine, the wireless bridge configured to receive the wireless communication signal and coupling a wireless access point to the wind turbine near a roof of the wind turbine, wherein the wireless access point is configured to communicate with at least one user computing device within an access area of the wind turbine, the access area including an interior of the tower and the nacelle, and the sweep area. The method also includes communicatively coupling the wireless bridge to the wireless access point, and configuring the wireless bridge to forward, to a remote device, a data request from the user computing device, the data request received from the wireless access point.

A method of providing wireless communication to a user computing device at a wind turbine including a tower, a nacelle, and a plurality of rotor blades defining a sweep area is provided. The method includes transmitting a wireless signal from a communications network source, receiving the wireless signal by a wireless bridge coupled to an exterior of the wind turbine, and transmitting the wireless signal by the wireless bridge. The method also includes receiving the wireless signal by the wireless access point coupled to the wind turbine near a roof of the wind turbine, and transmitting the wireless signal by the wireless access point to at least one user computing device within an access area of the wind turbine, the access area including an interior of the tower and the nacelle, and the sweep area.

A system for providing wireless communication to a user computing device at a wind turbine including a tower, a nacelle, and a plurality of rotor blades defining a sweep area is provided. The system includes a communications network source for providing a wireless signal from a communications network, a wireless bridge coupled to an exterior of a parent wind turbine configured to receive the wireless communication signal, and a wireless access point coupled to the wind turbine near a location of the wind turbine including at least one of a roof, at the base, and the tower, the wireless access point communicatively coupled to the wireless bridge and configured to transmit the wireless signal to at least one user computing device within an access area of the wind turbine, the access area including an interior of the tower and the nacelle, and the sweep area.

### BRIEF DESCRIPTION OF THE DRAWINGS

FIG. 1 is a schematic view of an exemplary wind turbine.

FIG. 2 is a block diagram illustrating an exemplary system for providing wireless communication to a wind farm.

FIG. 3 is a flowchart of an exemplary method for configuring a system to provide wireless communication to a wind farm.

### DETAILED DESCRIPTION OF THE INVENTION

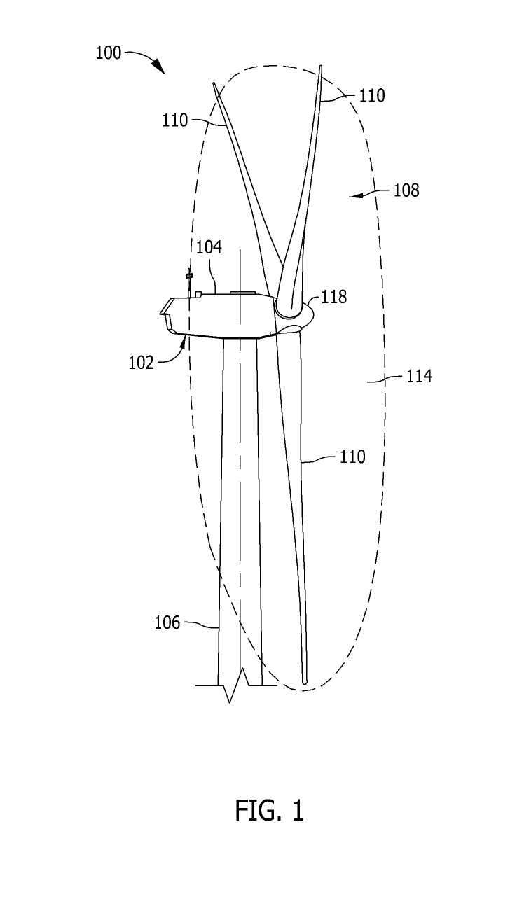

FIG. 1 is a schematic view of an exemplary wind turbine 100. Wind turbine 100 includes a nacelle 102 with a roof 104 housing a generator (not shown in FIG. 1). Nacelle 102 is mounted on a tower 106 extending to a pad (a portion of tower 106 being shown in FIG. 1). Tower 106 may be any height that facilitates operation of wind turbine 100 as described herein. Wind turbine 100 also includes a rotor 108 that includes rotor blades 110 attached to a rotating hub 112. Rotor blades 110 rotate in a substantially arcuate path or sweep area 114 defined by the area in which rotor blades 110 rotate around hub 112. Wind turbine 100 may include any number of rotor blades 110 that facilitate operation of wind turbine 100 as described herein. In the exemplary embodiment, wind turbine 100 includes a gearbox (not shown in FIG. 1) rotatingly coupled to rotor 108 and to the generator.

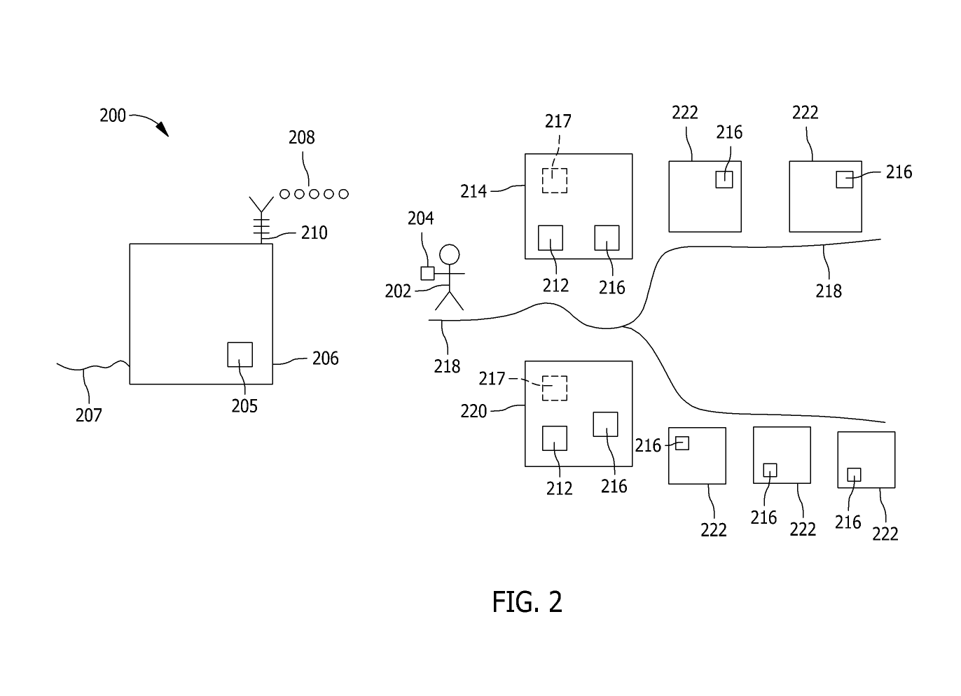

FIG. 2 is a block diagram illustrating an exemplary system 200 for providing wireless communication to a wind turbine 100 within a wind farm. In the exemplary embodiment, system 200 is designed to provide a user 202 wireless communication for a user computing device 204 when user 202 is at a wind farm. User computing device 204 is any device capable of bi-lateral data transfer and interaction with user 202. In some embodiments, user computing device 204 includes at least one presentation device capable of conveying information to user 202. The presentation device may include, without limitation, a display device (e.g., a liquid crystal display (LCD), organic light emitting diode (OLED) display, or “electronic ink” display) and/or an audio output device (e.g., a speaker or headphones). In some embodiments, the presentation device includes an output adapter, such as a video adapter and/or an audio adapter. An output adapter is operatively coupled to a processor and configured to be operatively coupled to an output device, such as a display device or an audio output device.

In some embodiments, computing device 204 includes an input device for receiving input from user 202. The input device may include, for example, a keyboard, a pointing device, a mouse, a stylus, a touch sensitive panel (e.g., a touch pad or a touch screen), a gyroscope, an accelerometer, a position detector, and/or an audio input device. A single component, such as a touch screen, may function as both an output device of the presentation device and the input device.

In the exemplary embodiment, base station 206 transmits a communications signal 208 by a base station antenna 210 to a wireless bridge 212 at a first parent wind turbine 214. In one embodiment, base station 206 and antenna 210 are communicatively coupled to a computing device 205 and a network communications link 207 that provides signal 208. Communications signal 208 can be any communications signal that enables a bi-lateral transmission of data including, but not limited to, a cellular phone technology (e.g., the Global Standard for Mobile communication (GSM)), radio frequency (RF), BLUETOOTH, an IEEE 802.11 standard (e.g., 802.11(g) or 802.11(n)), Worldwide Interoperability for Microwave Access (WIMAX), or any other suitable communication means. In one embodiment, base station antenna 210 is mounted to base station 206 and configured to transmit signal 208 at least twenty miles to bridge 212. In one embodiment, antenna 210 is a Cisco™ Aironet 1400 Series Wireless Bridge, commercially available from Cisco Systems Corporation headquartered in San Jose, Calif. Alternatively, antenna 210 can be any antenna or transmission device configured to transmit signal 208 any distance that enables communication at a wind farm as described herein.

In the exemplary embodiment, bridge 212 is a backhaul coupled to tower 106 (shown in FIG. 1) of first parent wind turbine 214. In the exemplary embodiment, bridge 212 is a Cisco™ 3500 Series Access Point commercially available from Cisco Systems Corporation headquartered in San Jose, Calif. Wireless bridge 212 receives and transmits signal 208 to an access point 216 mounted to an inner roof 104 of turbine 214. In an alternative embodiment, wireless bridge 212 is mounted at a base or on the exterior of tower 106 of turbine 214. In the exemplary embodiment, communication between wireless bridge 212 and access point 216 is provided using a wired network connection (e.g., Ethernet or an optical fiber). In one embodiment, a controller and switch 217 communicatively couple wireless bridge 212 and access point 216 to route signal 208 from bridge 212 to access point 216. Alternatively, communication between wireless bridge 212 and access point 216 is achieved wirelessly using an IEEE 802.11 standard (e.g., 802.11(g) or 802.11(n)), BLUETOOTH, or any other suitable wireless signal, such that wireless bridge 212 transmits signal 208 to access point 216.

Access point 216 broadcasts signal 208 throughout parent wind turbine 214. In one embodiment, access point 216 broadcasts signal 208 hemispherically throughout turbine 214 such that signal 208 extends to all components of turbine 214 including, but not limited to, nacelle 102, tower 106, blades 110, rotating hub 112, and sweep area 114. In one embodiment, access point 216 broadcasts signal 208 such that signal 208 extends to a wind farm service road 218, a second parent wind turbine 220, and an adjacent child wind turbine 222. In the exemplary embodiment, access point 216 broadcasts signal 208 1.2 miles surrounding turbine 214. In alternative embodiment, access point 216 broadcasts signal 208 two hundred feet surrounding turbine 214. Alternatively, access point 216 may broadcast signal 208 any distance and in any shape that enables communication at a wind farm as described herein.

Similar to first parent wind turbine 214, second parent wind turbine 220 and child wind turbines 222 have access point 216 coupled to each respective wind turbine 220 and 222. In the exemplary embodiment, first parent wind turbine 214 transmits signal 208 to access point 216 mounted in adjacent parent wind turbines, such as second parent wind turbine 220. In one embodiment, second parent wind turbine 220 includes wireless bridge 212 coupled to tower 106 (shown in FIG. 1) such that wireless bridge 212 is capable of receiving signal 208 from antenna 210. In such an embodiment, wireless bridge 212 is communicatively coupled to access point 216 and access point 216 is configured to transmit signal 208 to any parent wind turbines and any adjacent child wind turbines 222 should first parent wind turbine 214 lose communication with signal 208 from antenna 210.

Parent wind turbines 214 and 220 are configured to receive and transmit signal 208 from antenna 210 to access point 216 mounted in parent wind turbines 214 and 220 such that access point 216 extends signal 208 to any adjacent child wind turbine 222 and more specifically, to access point 216 mounted in each child wind turbine 222. Similarly, access point 216 within each child wind turbine 222 is configured to extend signal 208 to any adjacent child wind turbine 222.

Access point 216 mounted in turbines 220 and 222 is configured to broadcast signal 208 throughout turbine 214 such that signal 208 extends to all components of each turbine 220 and 222. In the exemplary embodiment, each child wind turbine 222 is communicatively coupled to a parent wind turbine and base station 206.

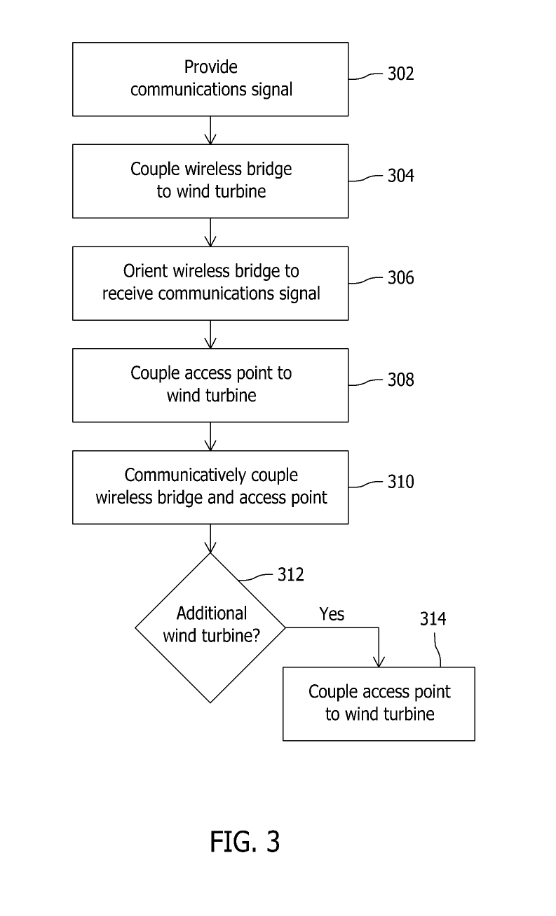

FIG. 3 is a flowchart of an exemplary method 300 for configuring a system to provide wireless communication to a wind farm. The method includes providing 302 communications signal 208 from antenna 210 at base 206. A wireless bridge 212 is coupled 304 to an exterior of first parent wind turbine 214. In one embodiment, wireless bridge 212 is coupled 304 to tower 106 of first parent wind turbine 214 at a location accessible to a user. For example, wireless bridge 212 can be positioned at a height of 8 feet from a base of tower 106, such that wireless bridge 212 is accessible to a user standing on a bed of a truck. Alternatively, wireless bridge 212 can be coupled 304 at any location on tower 106 that facilities providing wireless communication as described herein such as at a height of 40 feet from the base of tower 106. In the exemplary embodiment, wireless bridge 212 is oriented 306 such that communications signal 208 provided 302 from base 206 is received. In one embodiment, wireless bridge is oriented 306 to be in a direct line-of-sight with antenna 210. Wireless bridge 212 can be coupled 304 and oriented 306 anywhere on or inside first parent wind turbine 214 that provides a link between antenna 210 and wireless bridge 212 through signal 208.

In the exemplary embodiment, access point 216 is coupled 308 to turbine 214 near roof 104 of turbine 214. In one embodiment, access point 216 is coupled 308 and substantially aligned with a central vertical axis of tower 106. Coupling 308 access point 216 to be substantially aligned with a central vertical axis of tower 106 enables only one access point 216 to broadcast signal 208 through nacelle 102, tower 106, and rotor 108 to the ground and all areas serviceable by a user 202 monitoring and/or repairing wind turbine 100. Coupling 308 access point 216 to be substantially aligned with a central vertical axis of tower 106 enables signal 208 to be broadcast to all serviceable areas of wind turbine 100 by penetrating the harsh electromagnetic profile of wind turbine 100 and the components of wind turbine 100 that may block prevent wireless signals from being transmitted throughout wind turbine 100. In the exemplary embodiment, wireless bridge 212 and access point 216 are communicatively coupled within turbine 214. In such an embodiment, a wired connection is made from both wireless bridge 212 and access point 216 to controller and switch 217, such that signal 208 received from wireless bridge 212 is routed to access point 216 by switch 217.

If a determination is made 312 that additional wind turbines should receive signal 208, an access point 216 is coupled 314 near to each additional wind turbine 100 near roof 104 of each additional wind turbine 100. As described above, first parent wind turbine 214 extends signal 208 to other parent wind turbines, such as second wind turbine 220 and each parent wind turbine extends signal 208 to adjacent child wind turbines 222. Child wind turbines 222 repeat signal 208 such that a wireless communications signal 208 is available at each turbine within a wind farm.

The embodiments described herein provide a method for providing wireless communication to a wind farm. A user performing maintenance and/or repair of wind turbines within a wind farm will be provided a wireless communications signal such that information can be transferred bi-laterally with a remote location to provide the user with information that will enable the maintenance and/or repair of the wind turbine to be more efficient.

Exemplary embodiments of a wind farm wireless communications system are described above in detail. The wireless communications system and wind turbine are not limited to the specific embodiments described herein, but rather each component may be utilized independently and separately from other components described herein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method of providing wireless communication to a user computing device at a wind turbine including a tower, a nacelle, and a plurality of rotor blades defining a sweep area, the method comprising:
coupling a wireless bridge to an exterior of the wind turbine, the wireless bridge configured to receive a wireless communication signal;
coupling a wireless access point to the wind turbine near a roof of the wind turbine, wherein the wireless access point is configured to communicate with at least one user computing device within an access area of the wind turbine, the access area including an interior of the tower and the nacelle, and the sweep area;
communicatively coupling the wireless bridge to the wireless access point; and
configuring the wireless bridge to forward, to a remote device, a data request from the user computing device, the data request received from the wireless access point.

2. A method in accordance with claim 1, further comprising coupling a second wireless access point to a second wind turbine, the second wireless access point configured to communicate with the wireless access point coupled to the wind turbine near a location including at least one of the roof, a base of the tower, and an exterior the tower.

3. A method in accordance with claim 2, wherein coupling a second wireless access point to a second wind turbine further comprises coupling a second wireless access point to a second wind turbine such that the second wireless access point is configured to communicate with at least one user computing device within an access area of the second wind turbine, the access area including an interior of the tower and the nacelle, and the sweep area.

4. A method in accordance with claim 1, wherein coupling a wireless access point to the wind turbine further comprises coupling a wireless access point to the wind turbine such that the wireless access point is configured to communicate with at least one user computing devices within an access area of the wind turbine including a rotatable hub of the wind turbine.

5. A method in accordance with claim 1, wherein coupling a wireless access point to the wind turbine further comprises coupling a wireless access point to the wind turbine such that the wireless access point is configured to communicate with at least one user computing devices within an access area of the wind turbine including an exterior of the nacelle of the wind turbine.

6. A method in accordance with claim 1, wherein coupling a wireless access point to the wind turbine further comprises coupling a wireless access point to the wind turbine such that the wireless access point is configured to communicate with at least one user computing devices within an access area of the wind turbine including a pad of the wind turbine.

7. A method in accordance with claim 1, wherein coupling a wireless access point to the wind turbine further comprises coupling a wireless access point to the wind turbine such that the wireless access point is configured to communicate with at least one user computing devices within an access area of the wind turbine that extends about 1000 feet around the wind turbine.

8. A method of providing wireless communication to a user computing device at a wind turbine including a tower, a nacelle, and a plurality of rotor blades defining a sweep area, the method comprising:
transmitting a wireless signal from a communications network source;
receiving the wireless signal by a wireless bridge coupled to an exterior of the wind turbine;
transmitting the wireless signal by the wireless bridge;
receiving the wireless signal by the wireless access point coupled to the wind turbine near a roof of the wind turbine; and
transmitting the wireless signal by the wireless access point to at least one user computing device within an access area of the wind turbine, the access area including an interior of the tower and the nacelle, and the sweep area.

9. A method in accordance with claim 8, further comprising receiving the wireless signal, transmitted by the wireless access point, by a second wireless access point coupled to a second wind turbine.

10. A method in accordance with claim 9, further comprising transmitting the wireless signal by the second wireless access point to at least one user computing device within an access area of the second wind turbine, the access area including an interior of the tower and the nacelle, and the sweep area.

11. A method in accordance with claim 10, wherein transmitting the wireless signal by the second wireless access point to at least one user computing device within an access area of the second wind turbine further comprises transmitting the wireless signal by the second wireless access point to at least one user computing device within an access area of the second wind turbine that extends about at least 200 feet around the second wind turbine.

12. A method in accordance with claim 8, wherein transmitting the wireless signal by the wireless access point further comprises transmitting the wireless signal such that a connection between the user computing device and the communications network source is available.

13. A method in accordance with claim 8, wherein transmitting the wireless signal by the wireless access point to at least one user computing device within an access area of the wind turbine further comprises transmitting the wireless signal by the wireless access point to at least one user computing device within an access area of the wind turbine that extends at least 200 feet around the wind turbine.

14. A system for providing wireless communication to a user computing device at a wind turbine including a tower, a nacelle, and a plurality of rotor blades defining a sweep area, the system comprising:
a communications network source for providing a wireless signal from a communications network;
a wireless bridge coupled to an exterior of a parent wind turbine configured to receive the wireless communication signal; and
a wireless access point coupled to the wind turbine near a location of the wind turbine including at least one of a roof, at the base, and the tower, the wireless access point communicatively coupled to the wireless bridge and configured to transmit the wireless signal to at least one user computing device within an access area of the wind turbine, the access area including an interior of the tower and the nacelle, and the sweep area.

15. A system in accordance with claim 14, wherein the wireless bridge is a back haul.

16. A system in accordance with claim 14, wherein the wireless access point is configured to transmit the signal at least 200 feet around the wind turbine.

17. A system in accordance with claim 14, further comprising a second wireless access point coupled to a second wind turbine, the second wireless access point communicatively coupled to the first access point.

18. A system in accordance with claim 17, wherein the second wireless access point is configured to transmit the wireless signal to at least one user computing device within an access area of the second wind turbine, the access area including an interior of the tower and the nacelle, and the sweep area.

19. A system in accordance with claim 17, wherein the second wireless access point is configured to transmit the wireless signal at least 200 feet around the second wind turbine.

20. A system in accordance with claim 17, further comprising a third wireless access point coupled to a third wind turbine, the third wireless access point communicatively coupled to the second access point and configured to transmit the wireless signal to at least one user computing device within an access area of the second wind turbine, the access area including an interior of the tower and the nacelle, and the sweep area.
